(19) United States
(12) Patent Application Publication
(10) Pub. No.: US 2006/0035651 A1
(43) Pub. Date: Feb. 16, 2006

(54) System and method for remote control of media devices

(76) Inventors: Jarmo Arponen, Tuusula (FI); Harald Kaaja, Jarvenpaa (FI); Markku A. Oksanen, Helsinki (FI)

Correspondence Address: FOLEY & LARDNER LLP, 321 NORTH CLARK STREET, SUITE 2800, CHICAGO, IL, 60610-4764, US

(21) Appl. No.: 10/915,586

(22) Filed: Aug. 10, 2004

(51) Int. Cl. H04Q 7/20

(52) U.S. Cl. 455/466

(57) ABSTRACT

The techniques described transmit messages from a mobile device to a digital television (or other media) appliance. One technique associates a mobile unit with a customer premise equipment (CPE) device where the CPE device is a media device at a first location and the mobile unit is at a second location distant from the first location. The technique further receives a download code from the mobile unit where the download code corresponds to selectable content and communicates commands to download the selectable content to the CPE device based on the received download code

### BACKGROUND OF THE INVENTION

1. Field of the Invention

The present invention relates generally to wireless communication technology. More particularly, the present invention relates to a system and method for remote control of media devices.

2. Description of the Related Art

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

Although video cassette recorders (VCRs), media recorders and similar content storage devices are in widespread use in homes across the world, no remote control from outside the home is available for these devices. Conventional systems do not allow for the selection of free media content to store on a media recording evice or remote content purchasing for fee-based content.

German Patent Disclosure DE10139331 describes a method for transmitting short messages from a mobile telephone to a digital television appliance. This German document indicates that short messages service (SMS) messages can be communicated from mobile phones to a television if there is an apparatus connected to the television with Internet access. The German document teaches transmitting messages received from the Internet using a transmitter that communicates with the television. However, the system described in the German document is limited in many ways.

Thus, there is a need to provide an improved system and method for remote control of media devices. Even further, there is a need to communicate programming messages to a content provider that provides selected content to a media device. Further still, there is a need to associate terminals to facilitate the delivery of content to a media device as selected by a remote unit.

### SUMMARY OF THE INVENTION

Briefly, the present invention relates to techniques for transmitting messages from a mobile device to a digital television (or other media) appliance. One exemplary embodiment relates to a method of controlling a media device at a first location using a mobile unit at a second location, where the second location is distant from the first location. The method includes associating a mobile unit with a customer premise equipment (CPE) device where the CPE device is a media device at a first location and the mobile unit is at a second location distant from the first location. The method further includes receiving a download code from the mobile unit where the download code corresponds to selectable content and communicating commands to download the selectable content to the CPE device based on the received download code.

Another exemplary embodiment relates to a system for controlling a media device at a first location using a mobile unit at a second location. The system includes a communication device that communicates commands to control media programming, a service provider that communicates with the communication device to receive commands regarding the control of media programming and provides instructions to carry out the control of the media programming, and a media device that receives media programming and carries out commands to control media programming from the communication device.

Another exemplary embodiment relates to a device configured for controlling media programming at a media device located in a different local area from the device. The device includes a memory configured to contain instructions regarding control of media programming and a device identifier. The device also includes a processor that communicates control instructions to a service provider. The processor communicates the control instructions to a service provider using a messaging protocol such as short message service (SMS) signals, text messages, or other wireless messaging method to instruct the downloading of selected media programming to an associated media device based on the device identifier.

Another exemplary embodiment relates to a computer program product that controls a media device at a first location using a mobile unit at a second location, wherein the second location is distant from the first location. The computer program product includes computer code to associate a mobile unit with a customer premise equipment (CPE) device, wherein the CPE device is a media device at a first location and the mobile unit is at a second location distant from the first location. There is also computer code to receive a download code from the mobile unit, wherein the download code corresponds to selectable content; and computer code to communicate commands to download the selectable content to the CPE device based on the received download code.

### BRIEF DESCRIPTION OF DRAWINGS

FIG. 1 is a diagram depicting a system for remote control of a media device in accordance with an exemplary embodiment.

FIG. 2 is a flow diagram depicting exemplary operations in the remote control system of FIG. 1.

FIG. 3 is a diagram depicting data and control flow in the remote control system of FIG. 1 where the content is purchased.

FIG. 4 is a diagram depicting a communication system including the remote control feature of FIG. 1.

### DETAILED DESCRIPTION OF EXEMPLARY EMBODIMENTS

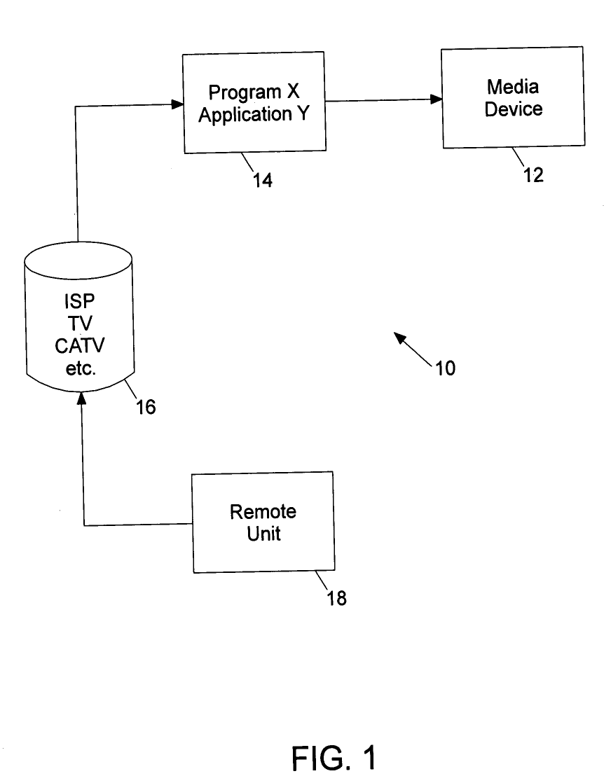

FIG. 1 illustrates a system 10 including a media device 12, a program 14, a content provider 16, and a remote unit 18. The media device 12 can be a video cassette recorder (VCR), a digital video recorder (DVR), a recordable DVD player, media recorder, or other content storage device. The program 14 can include content, such as a movie, song, game, or other media content, and is associated with an application. The content provider 16 can be an Internet service provider (ISP), a cable television (CATV) provider, a television (TV) station, or other broadcasting company. The remote unit 18 can be a mobile phone, a computer, or any other device that can communicate information to the content provider 16.

A user can send a control command using the remote unit 18 to the media device 12. In an exemplary embodiment, the control command is communicated over a short message service (SMS) or similar data connection. While SMS is mentioned as one possible messaging method, it should be understood that other suitable messaging methods and protocol can also be used and that the invention described and claimed here is not limited to SMS. The user can select free content or fee-based content. The purchase can be made digitally and the content can be communicated to the media device 12 even though the purchase interaction takes place between the remote unit 18 and a backend system that handles charging, content delivery, and digital rights management (DRM).

The remote unit 18 can communicate over a cellular network (or short range radio) to a mobile operator or access point and from there to a service provider. Alternatively, the mobile operator communicates directly to the media device 12. Therefore, a certain programming message may include combined transmission channels—the identifier for the media device 12 and the associated application identifier. The application identifier can include information on the program and its associated application. If the program is available on-demand, it can be viewed as it downloads (if permitted by the media device 12).

In one embodiment, the media device 12 can be a Media Master device sold by Nokia Corporation of Finland. The user can also receive a SMS message at the remote unit 18 with remote programming information from advertisers. A wide range of possibilities exist for how the user obtains programming information. For example, the user may read a programming code from a newspaper listing, such as a TV guide listing. Alternatively, the information may be available on the Internet or on a WAP (wireless application protocol) phone. Such information may contain programming tags that can be sent directly to the media device 12.

In one implementation, the content provider 16 receives an order from an SMS message and locates the user's home media device 12. When the media device 12 is located and the service is available, the content provider 16 can initiate the delivery of data to the media device 12. Billing for the service can be done through a phone bill where the remote unit 18 is a phone or based on a pre-payment method.

Advantageously, content can be downloaded directly from a content provider to a media device terminal and the messaging from the remote unit 18 goes to the content provider, irrespective of the locations of the remote unit 18 and the terminal. The remote unit can be matched with its media device 12 and programming events can be selectively triggered.

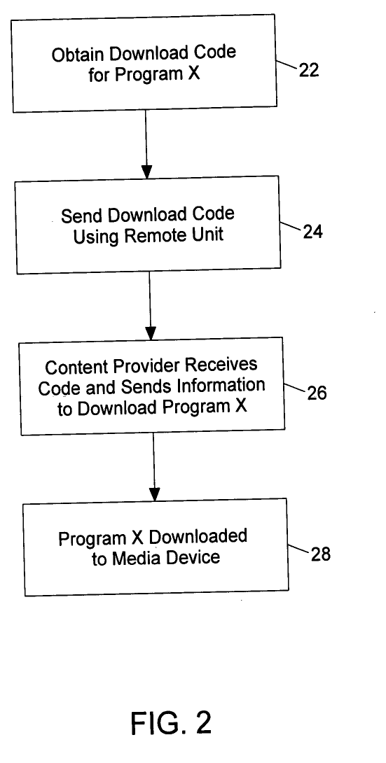

FIG. 2 illustrates a flow diagram of operations performed in the remote control system of FIG. 1. Additional, fewer, or different operations may be preformed, depending on the embodiment. In an operation 22, the user obtains a download code for a program X. The user can obtain this code in many different ways, as described with reference to FIG. 1. The code may be included in TV listings in a newspaper or on the Internet, for example.

In an operation 24, the download code is communicated using a remote unit, such as a phone having SMS capability, a phone with text messaging, or any communication device. In an operation 26, a content provider receives the download code and sends information to initiate the downloading of program X. The content provider can be an Internet Service Provider (ISP), a cable television (CATV) provider, a phone company, or any content provider. In an operation 28, the program X is downloaded to a media device. The program X can be a sporting event, movie, television program, a song, or any other type of content.

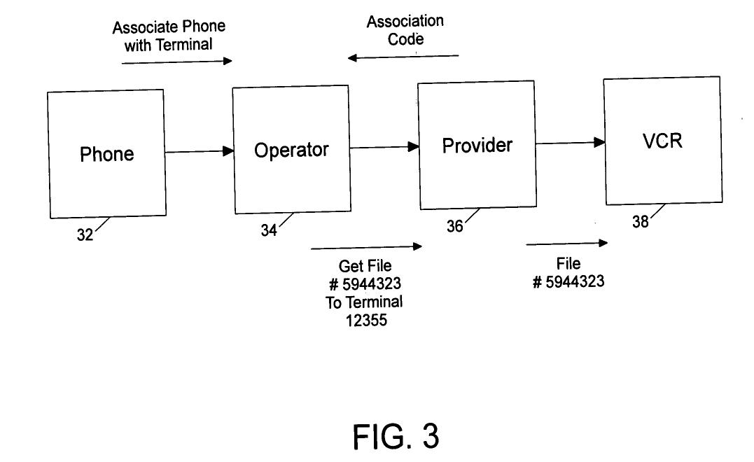

FIG. 3 illustrates data and control flow in the remote control system described with reference to FIG. 1 where the content is purchased. Upon activation of the remote control service with a phone 32, an operator 34 associates the phone 32 with a media device such as a VCR 38. A service provider 36 sends an association code to the phone 32 or an Internet protocol (IP) address, media access control (MAC) identifier (ID), or some unique identifier. The phone 32 can obtain the identifier for the VCR 38 from an IRDA (infrared data association), RFID (radio frequency identification), Bluetooth, WLAN (wireless local area network), or UWB (ultrawide bandwidth) system. The phone 32 can act as a remote control device during the association phase.

The user can be associated with a given service and terminal in the following manner. The service provider 36 can send an access code that is always sent together with the programming data. By way of example, the VCR 38 can have the code 12355. Thus, when the operator 34 receives a message to get the file number 5944323, it communicates the message to the service provider 36 to download file number 5944323 to terminal 12355. The file can be transferred over a broadcast medium, such as cable television, or through the Internet.

A variety of implementation alternatives are possible. For example, the system described can also be used to configure and program a home computer as well as synchronize the remote unit and computer. Further, remote data can be redirected from the remote unit to other devices.

As a result, purchased content can be redirected to any appropriate customer premise equipment (CPE) devices through the media device using external data interfaces, such as a memory card, a short range radio connection, or a wireline connection. Moreover, any storable digital content can be purchased and remotely downloaded to the appropriate home CPE device, e.g. new update/program to a PC, DVD, PDA. A service profile for a user can be combined into a single SMS message in many ways such that one SMS consists of either one single service, a service set, or dynamically created e.g. “10 most wanted programs ordered.”

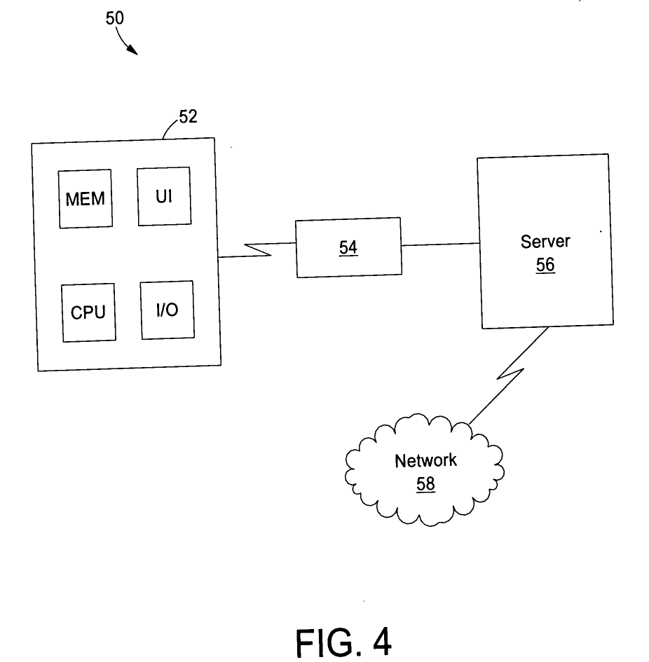

FIG. 4 illustrates a communication system 50 including the remote control features described herein. The exemplary embodiments described herein can be applied to a wide number of communication systems. Communication system 50 includes a terminal equipment (TE) device 52, an access point (AP) 54, a server 56, and a network 58. The TE device 52 can include memory (MEM), a central processing unit (CPU), a user interface (UI), and an input-output interface (I/O). The memory can include non-volatile memory for storing applications that control the CPU and random access memory for data processing. The I/O interface can include a network interface card of a wireless local area network, such as one of the cards based on the IEEE 802.11 standards. The TE device 52 can perform the communication operations described with respect to FIGS. 1-3 relative to the remote control of a media device.

The TE device 52 can be connected to the network 58 (e.g., a local area network (LAN), the Internet, a phone network) via the access point 54 and further to the server 56. The TE device 52 can also communicate directly with the server 56, for instance using a cable, infrared, or a data transmission at radio frequencies. The server 56 can provide various processing functions for the TE device 52.

The TE device 52 can be any portable electronic device. For example a personal digital assistant (PDA) device, remote controller or a combination of an earpiece and a microphone. The TE device 52 can be a supplementary device used by a computer or a mobile station, in which case the data transmission to the server 56 can be arranged via a computer or a mobile station. In an exemplary embodiment, the TE device 52 is a mobile station communicating with a public land mobile network, to which also the server 56 is functionally connected. The TE device 52 connected to the network 58 includes mobile station functionality for communicating with the network 58 wirelessly. The network 18 can be any known wireless network, for instance a network supporting the GSM service, a network supporting the GPRS (General Packet Radio Service), or a third generation mobile network, such the UMTS (Universal Mobile Telecommunications System) network according to the 3GPP (3^{rd} Generation Partnership Project) standard. The functionality of the server 56 can also be implemented in the mobile network. The TE device 56 can be a mobile phone used for speaking only, or it can also contain PDA (Personal Digital Assistant) functionality.

While several embodiments of the invention have been described, it is to be understood that modifications and changes will occur to those skilled in the art to which the invention pertains. The invention is not limited to a particular embodiment, but extends to various modifications, combinations, and permutations that nevertheless fall within the scope and spirit of the appended claims.

1. A method of controlling a media device at a first location using a mobile unit at a second location, wherein the second location is distant from the first location, the method comprising:
associating a mobile unit with a customer premise equipment (CPE) device, wherein the CPE device is a media device at a first location and the mobile unit is at a second location distant from the first location;
receiving a download code from the mobile unit, wherein the download code corresponds to selectable content; and
communicating commands to download the selectable content to the CPE device based on the received download code.

2. The method of claim 1, wherein the downloadable code is received by a service provider.

3. The method of claim 2, wherein the service provider communicates commands to download the selectable content to a content provider.

4. The method of claim 2, wherein the service provider assesses a charge to an account corresponding to the mobile unit, the charge being a fee for obtaining the selectable content.

5. The method of claim 1, wherein the CPE device comprises a device for presenting programs on a television.

6. The method of claim 1, further comprising downloading the selectable content via an Internet data transfer.

7. The method of claim 1, further comprising downloading the selectable content via a communication connection with a content provider.

8. The method of claim 1, wherein the download code is communicated using a short message service (SMS) signal.

9. A system for controlling a media device at a first location using a mobile unit at a second location, the system comprising:
a communication device that communicates commands to control media programming;
a service provider that communicates with the communication device to receive commands regarding the control of media programming and provides instructions to carry out the control of the media programming; and
a media device that receives media programming and carries out commands to control media programming from the communication device.

10. The system of claim 9, further comprising a content provider that receives instructions from the service provider and, in response, provides media programming to the media device.

11. The system of claim 9, wherein the service provider communicates the media programming to the media device.

12. The system of claim 9, wherein the service provider associates the communication device with the media device in an association phase.

13. The system of claim 9, wherein the media programming can further comprise storable digital content.

14. The system of claim 9, wherein the media device further comprises a computer and the media programming comprises programming the computer.

15. The system of claim 9, wherein the system can be configured to redirect remote data from the communication device to the media device.

16. The system of claim 9, wherein the media device further comprises an external data interface which can be used to transfer the media programming to other devices.

17. A device configured for controlling media programming at a media device located in a different local area from the device, the device comprising:
a memory configured to contain instructions regarding control of media programming, the memory further comprising a device identifier; and
a processor that communicates control instructions to a service provider;
wherein the processor communicates the control instructions to a service provider using a wireless messaging method to instruct the downloading of selected media programming to an associated media device based on the device identifier.

18. The device of claim 17, wherein the device is associated with the associated media device during an association phase in which the device identifier and an identifier of the media device are obtained by the service provider.

19. A computer program product that controls a media device at a first location using a mobile unit at a second location, wherein the second location is distant from the first location, the computer program product comprising:
computer code to associate a mobile unit with a customer premise equipment (CPE) device, wherein the CPE device is a media device at a first location and the mobile unit is at a second location distant from the first location;
computer code to receive a download code from the mobile unit, wherein the download code corresponds to selectable content; and
computer code to communicate commands to download the selectable content to the CPE device based on the received download code.

20. The computer program product of claim 19, wherein the downloadable code is received by a service provider.

21. The computer program product of claim 20, wherein the service provider communicates commands to download the selectable content to a content provider.

22. The computer program product of claim 20, wherein the service provider assesses a charge to an account corresponding to the mobile unit, the charge being a fee for obtaining the selectable content.

23. The computer program product of claim 19, wherein the CPE device comprises a device for presenting programs on a television.

24. The computer program product of claim 19, further comprising computer code to download the selectable content via an Internet data transfer.

25. The computer program product of claim 19, further comprising computer code to download the selectable content via a communication connection with a content provider.
